(19) United States
(12) Patent Application Publication
(10) Pub. No.: US 2010/0284646 A1
(43) Pub. Date: Nov. 11, 2010

(54) FIBER OPTIC GRATING MEASURING DEVICE

(76) Inventors: Chia-Chin CHIANG, Kaohsiung County (TW); Li-Ren Tsai, Taoyuan County (TW)

Correspondence Address: Muncy, Geissler, Olds & Lowe, PLLC, 4000 Legato Road, Suite 310, FAIRFAX, VA, 22033, US

(21) Appl. No.: 12/564,370

(22) Filed: Sep. 22, 2009

(30) Foreign Application Priority Data
May 5, 2009 (TW) 098114828

(51) Int. Cl. G02B 6/00; G02B 6/34

(52) U.S. Cl. 385/13; 385/37

(57) ABSTRACT

A fiber optic grating measuring device includes a wide-band light source, an optical coupler coupled to the wide-band light source, and an output unit. A long-period fiber grating includes a first end coupled to the optical coupler and a second end coupled to the output unit. A first fiber Bragg grating is coupled to the optical coupler. The first fiber Bragg grating serves as a measuring terminal and is adapted to be mounted on an object having a physical quantity, such as a strain or temperature, to be measured by the fiber optic grating measuring device. A second fiber Bragg grating is coupled to the optical coupler. The second fiber Bragg grating serves as a free terminal and is located adjacent to the first fiber Bragg grating. The second fiber Bragg grating compensates an error resulting from a temperature change to increase the measuring accuracy.

### BACKGROUND OF THE INVENTION

1. Field of the Invention

The present invention relates to a fiber optic grating measuring device and, more particularly, to a fiber optic grating measuring device capable of measuring a physical quantity of an object with high accuracy.

2. Description of the Related Art

FIG. 1 shows a conventional fiber optic grating measuring device 9 including a light source 91, an optical coupler 92, a short period fiber Bragg grating (FBG) 93, a long period fiber grating (LPG) 94, and an optical power-to-voltage signal converter 95. The light source 91 is a laser diode that emits a laser beam to an Erbium doped fiber amplifier (EDFA) to emit a short-band light by amplifier spontaneous emission (ASE). When it is desired to measure a physical quantity such as temperature of an object, the FBG 93 is placed on the object, and the light source 91 sends the short-band light to the optical coupler 92 by a fiber optic. The optical coupler 92 guides the short-band light to the FBG 93, and a portion of the light with a specific wavelength is reflected by the FBG 93 back to the optical coupler 92, which, in turn, guides the reflected light with the specific wavelength to the LPG 94. Since the object expands or shrinks due to a change in its temperature, strain occurs in the fiber optic. The wavelength of reflective center of the light with the specific wavelength shifts due to a change in the strain. Thus, the temperature change of the object can be inferred by the wavelength difference passing through the reflective center of the light. Furthermore, the optical power-to-voltage signal converter 95 is a photoelectric diode that coverts the optical energy passing through the LPG 94 into a voltage signal. After suitable conversion and amplification, the voltage signal can be converted into a voltage signal that can be measured easily and accurately. An example of such a fiber optic grating measuring device is disclosed in Taiwan Patent Publication No. 585998.

Thus, the fiber optic grating measuring device 9 measures the physical quantity of the object by placing a single FBG 93 on the object. However, slight strain occurs in the fiber optic due to a change in the ambient temperature, and the slight strain causes slight shift of the wavelength of the reflective center of the light. Namely, the strain of the fiber optic itself affects the wavelength of the reflective center of the light, leading to an error in measurement.

Thus, a need exists for an improved fiber optic grating measuring device capable of measuring a physical quantity of the object with high accuracy.

### SUMMARY OF THE INVENTION

The primary objective of the present invention is to provide a fiber optic grating measuring device with increased measuring accuracy by compensating an error resulting from the temperature change of the object.

Another objective of the present invention is to provide a fiber optic grating measuring device that adjusts the measuring sensitivity according to the measuring needs, providing enhanced utility.

A fiber optic grating measuring device according to the preferred teachings of the present invention includes a wide-band light source, an optical coupler coupled to the wide-band light source, and an output unit. A long-period fiber grating includes a first end coupled to the optical coupler and a second end coupled to the output unit. A first fiber Bragg grating is coupled to the optical coupler. The first fiber Bragg grating serves as a measuring terminal and is adapted to be mounted on an object having a physical quantity, such as a strain or temperature, to be measured by the fiber optic grating measuring device. A second fiber Bragg grating is coupled to the optical coupler. The second fiber Bragg grating serves as a free terminal and is located adjacent to the first fiber Bragg grating. The second fiber Bragg grating compensates an error resulting from a temperature change to increase the measuring accuracy.

In preferred forms, an adjusting device is provided on the long period fiber grating to apply an external force to the long period fiber grating, such that the long period fiber grating deforms slightly to adjust the depth of the wave trough of the transmission spectrum of the long period fiber grating. Thus, differing measuring sensitivities can be provided according to measuring needs.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a perspective view of a conventional fiber optic grating measuring device.

FIG. 2 shows a perspective view of a fiber optic grating measuring device of a first embodiment according to the preferred teachings of the present invention.

FIG. 3 shows a spectrum of a long period fiber grating of the fiber optic grating measuring device of FIG. 2.

FIG. 4 shows a spectrum of the long period fiber grating of the fiber optic grating measuring device of FIG. 2 with an object measured by the fiber optic grating measuring device having a strain under action of an external force.

FIG. 5 shows a spectrum of the long period fiber grating of the fiber optic grating measuring device of FIG. 2 with the fiber optic having a change in temperature, illustrating a shift of the wavelength of the reflective center and compensation of the shift.

FIG. 6 shows an enlarged, cross sectional view of an adjusting device of the fiber optic grating measuring device of FIG. 2 and the long period fiber grating.

FIG. 7 shows a cross sectional view of the long period fiber grating and the adjusting device of FIG. 6 with the long period fiber grating bent.

FIG. 8 shows a transmission spectrum of the long period fiber grating of FIG. 7.

FIG. 9 shows a perspective view of a fiber optic grating measuring device of a second embodiment according to the preferred teachings of the present invention.

FIG. 10 shows a partial, enlarged, cross sectional view of an adjusting device of FIG. 9 and a long period fiber grating of the fiber optic grating measuring device.

FIG. 11 shows a partial, enlarged, cross sectional view of the adjusting device and the long period fiber grating of FIG. 10 with the long period fiber grating pulled in an axial direction by the adjusting device.

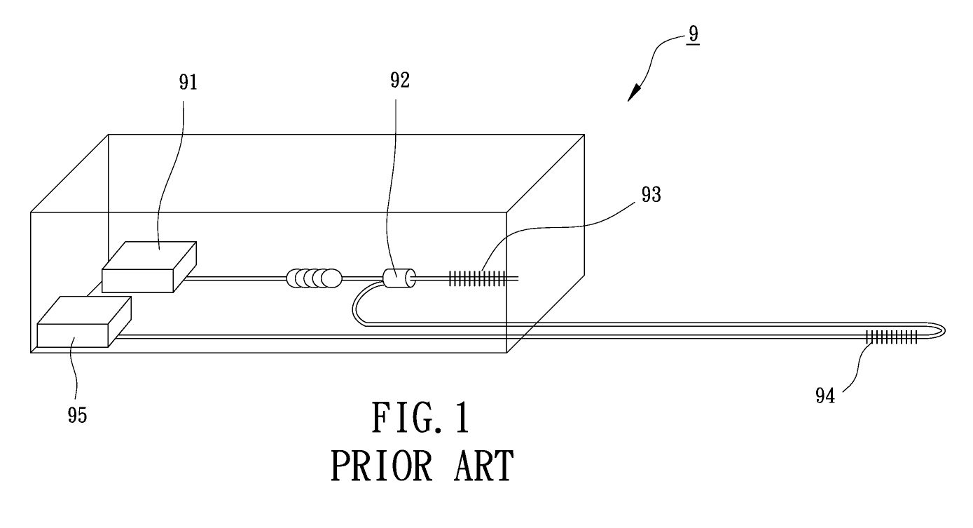

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “axial”, “lateral”, “width”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

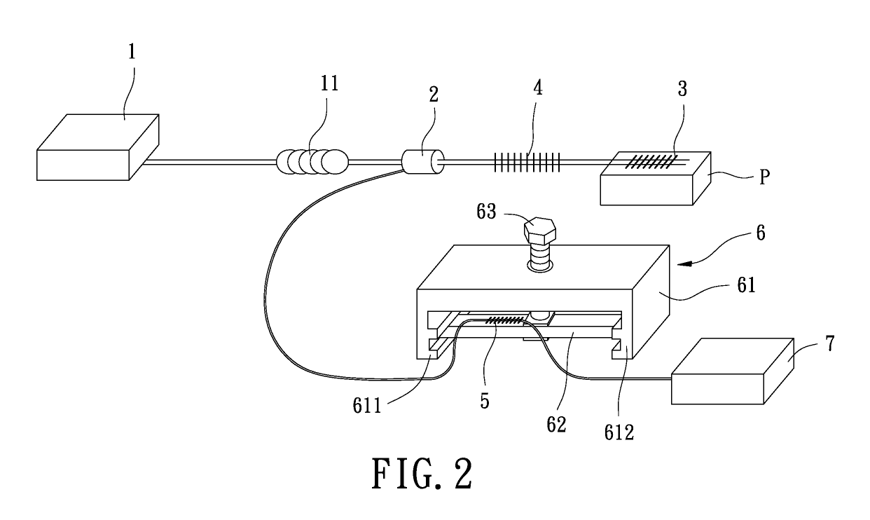

A fiber optic grating measuring device of a first embodiment according to the preferred teachings of the present invention is shown in FIG. 2 and generally includes a wide-band light source 1, an optical coupler 2, a first fiber Bragg grating 3, a second fiber Bragg grating 4, a long period fiber grating 5, an adjusting device 6, and an output unit 7. The wide-band light source 1 is coupled by a fiber optic to the optical coupler 2. The first and second fiber Bragg gratings 3 and 4 are also coupled to the optical coupler 2. An end of the long period fiber grating 5 is coupled to the optical coupler 2. The other end of the long period fiber grating 5 is coupled to the output unit 7. The long period fiber grating 5 is mounted on the adjusting device 6 to cause slight deformation of the long period fiber grating 5.

The wide-band light source 1 is preferably an illuminating element capable of emitting a wide-band light, such as a light-emitted diode (LED) or a laser diode. An Erbium doped fiber amplifier (EDFA) can be provided to emit a wide-band light by amplifier spontaneous emission. Thus, stable, high-power wide-band light can be continuously provided for measuring purposes.

The first and second fiber Bragg gratings 3 and 4 are connected by a fiber optic. The first fiber Bragg grating 3 is utilized as a measuring terminal and mounted on an object P whose physical quantity is to be measured. The second fiber Bragg grating 4 is utilized as a free terminal and located adjacent to the first fiber Bragg grating 3.

The adjusting device 6 is a micro-adjusting device for applying a lateral pressure to the long period fiber grating 5. The long period fiber grating 5 can be of external force type. The long period fiber grating 5 is coupled to the first and second fiber Bragg grating 3 and 4 through the optical coupler 2.

The adjusting device 6 includes a clamp 61, a carrier 62, and an adjusting member 63. The clamp 61 includes two clamping ends 611 and 612 for clamping two ends of the carrier 62 to fix the carrier 62 on the clamp 61. The long period fiber grating 5 is mounted on a side of the carrier 62. The adjusting member 63 shown in FIGS. 2, 6, and 7 is in the form of a bolt threadedly engaged with the carrier 62. Specifically, the adjusting member 63 extends through the clamp 61 and has an end presses against the side of the carrier 62.

The fiber optic grating measuring device of the first embodiment according to the preferred teachings of the present invention can be utilized to measure physical quantities (including but not limited to temperature or strain) of an object P. In this example, the fiber optic grating measuring device is utilized to measure the strain of the object P.

The wide-band light source 1 continuously provides the optical coupler 2 with the wide-band light, and the optical coupler 2 guides the wide-band light to the first and second fiber Bragg grating 3 and 4. The first fiber Bragg grating 3 reflects the light with a first wavelength T to the output unit 7 after passing through the optical coupler 2 and the long period fiber grating 5. The second fiber Bragg grating 4 reflects the light with a second wavelength M to the output unit 7 after passing through the optical coupler 2 and the long period fiber grating 5. The output unit 7 in the preferred form shown is a spectrometer. A shift of the wavelength of the reflective center of the light and the wavelength of the transmission center of the light can be observed by the spectrometer. The output unit 7 can be in other forms other than the spectrometer. As an example, the output unit 7 can be a photoelectric diode capable of converting the optical energy into a voltage signal or a current signal for output purposes.

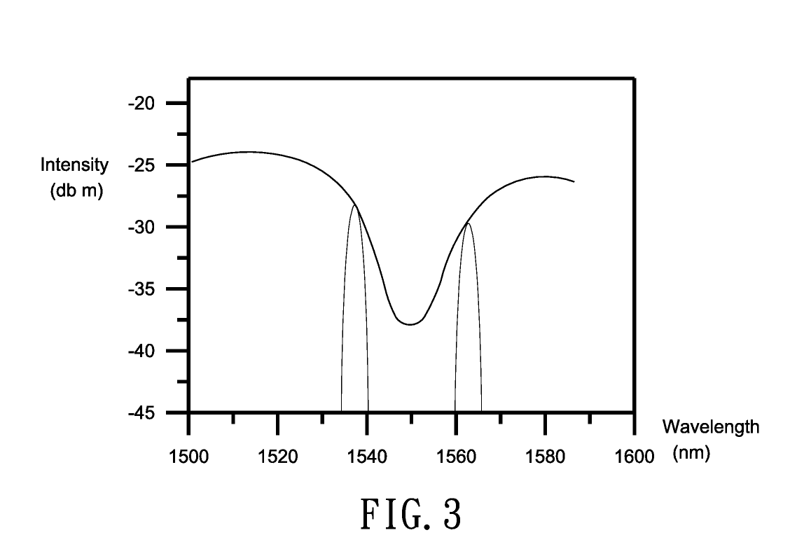

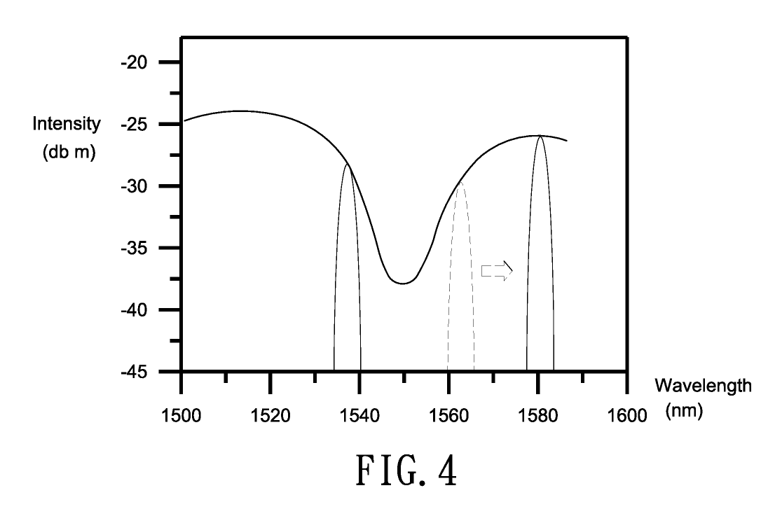

With reference to FIGS. 3 and 4, when the object P has a strain due to an external force or a change in temperature, the first fiber Bragg grating 3 has the same strain, such that the grating width of the first fiber Bragg grating 3 is changed, leading to a rightward shift from the wavelength T of the reflective center representing the strain amount to another wavelength T′ (see FIG. 4). Since the amount of the shift of the wavelength of the reflective center is in proportion to the strain of the object P, the strain of the object P can be inferred from the difference of the wavelength before and after the shift.

Furthermore, the object P and the fiber optic expand or shrink to an extent according to their coefficients of expansion due to a change in the ambient temperature, leading to a strain in the object P and the fiber optic. Namely, an error in the measurement may be caused by the change of the ambient temperature.

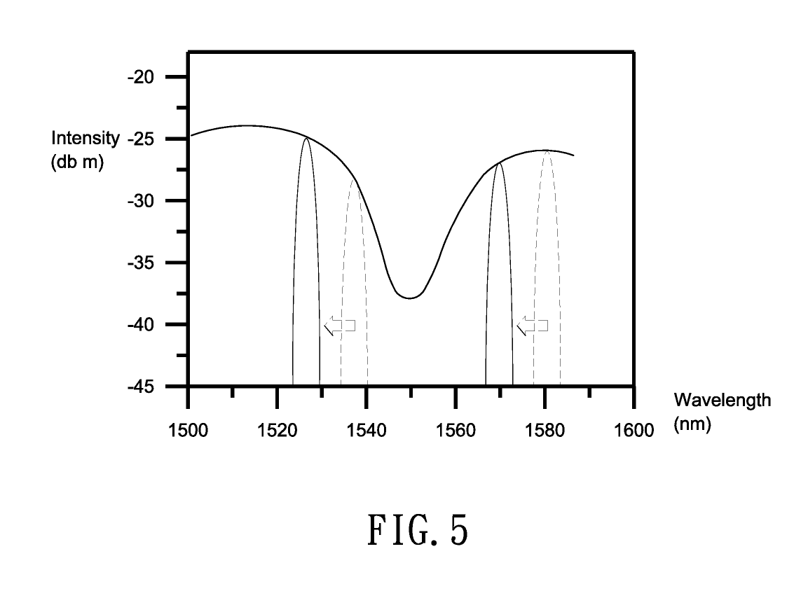

With reference to FIG. 5, by providing the second fiber Bragg grating 4 adjacent to the object P according to the teachings of the present invention, the strains of the first and second fiber Bragg gratings 3 and 4 resulting from the change of the ambient temperature are almost identical, so that the grating width of the second fiber Bragg grating 4 is also changed; namely, the wavelength of the reflective center of the light reflected by the second fiber Bragg grating 4 shifts. Since the first and second fiber Bragg gratings 3 and 4 simultaneously receive the wide-band light from the wide-band light source 1, the sum of the energy of the wavelengths of the reflective centers of the lights reflected by the first and second fiber Bragg gratings 3 and 4 is fixed. By this arrangement, when the wavelength of the reflective center of the light reflected by the second fiber Bragg grating 4 shifts in a direction, the wavelength of the reflective center of the light reflected by the first Bragg grating 3 also shifts in the same direction, as shown in FIG. 5. Thus, in a case that the ambient temperature changes during measurement of the physical quantity of the object P, the wavelength of the reflective center representing the temperature shifts leftward from the second wavelength M to another wavelength M′ by an amount (M′-M). At the same time, the wavelength of the reflective center representing the strain also shifts leftward together with the wavelength of the reflective center representing the temperature by the same amount (M′-M). By providing the second fiber Bragg grating 4 sensing the ambient temperature of the object P, the change in the wavelength of the reflective center result from the ambient temperature change can be compensated. The accuracy of measuring the strain amount of the object P is, thus, effectively increased.

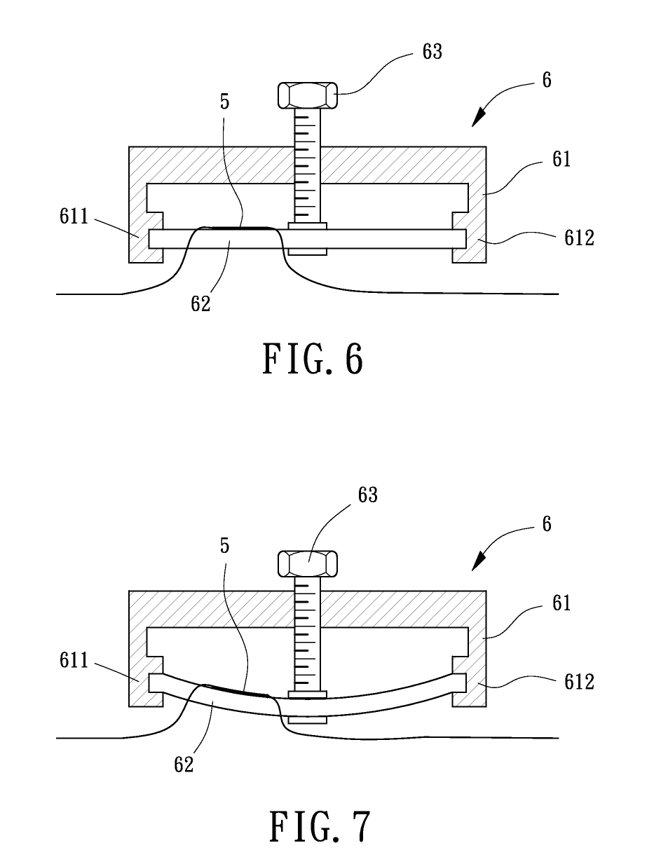

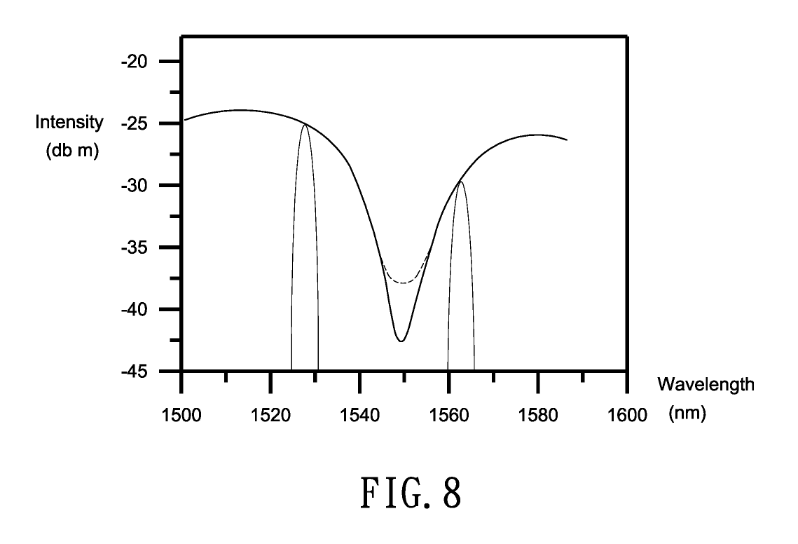

With reference to FIGS. 6 and 8, during measurement of the strain amount of the object P, the adjusting device 6 can be adjusted to apply a lateral force to the long period fiber grating 5, so that the long period fiber grating 5 slightly bends to change the grating width of the long period fiber grating 5 for adjusting the depth of the wave trough of the transmission spectrum of the long period fiber grating 5 (see FIG. 8). Since the long period fiber grating 5 will filter a portion of the reflective waves of the first and second fiber Bragg gratings 3 and 4, when the wavelength of the reflective center representing the temperature and the wavelength of the reflective center representing the strain shift upward in the spectrum, the wavelengths will move along the transmission waveforms of the long period fiber grating 5. Thus, the slope of the transmission waveforms of the long period fiber grating 5 can be changed by deforming the long period fiber grating 5 according to the teachings of the present invention. A larger slope means larger energy fluctuation per wavelength unit and, thus, higher measuring sensitivity. Thus, by adjusting the measuring sensitivity of the physical quantity of the object P, different sensitivities can be obtained according to the teachings of the present invention.

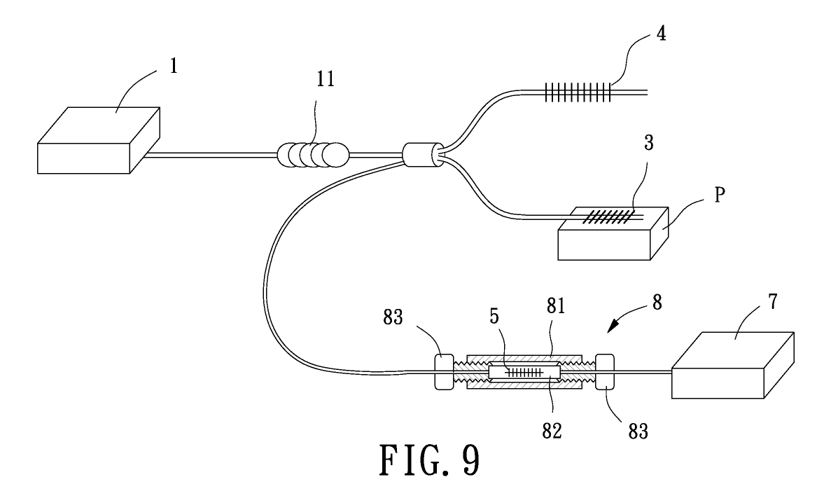

FIG. 9 shows a fiber optic grating measuring device of a second embodiment according to the preferred teachings of the present invention. Compared to the first embodiment, the first and second fiber Bragg gratings 3 and 4 are located at two different fiber optic. The first fiber Bragg grating 3 is mounted on the object P to be measured, and the second fiber Bragg grating 4 is mounted at a location adjacent to the object P to compensate the change in the wavelength of the reflective center due to a change in the temperature, avoiding measurement errors and, thus, increasing the measuring accuracy.

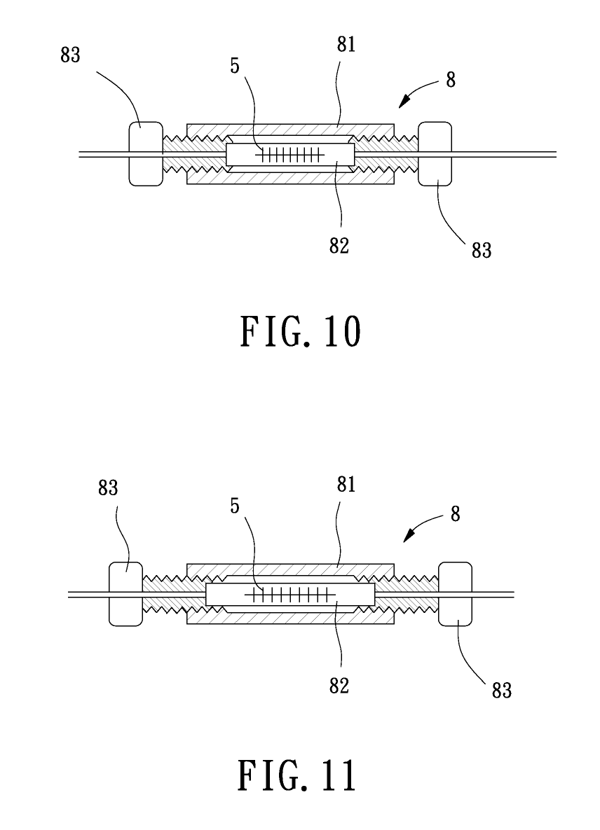

With reference to FIGS. 9-11, the adjusting device 8 of the second embodiment is capable of applying a pulling force to the long period fiber grating 5 in an axial direction of the long period fiber grating 5. Specifically, the adjusting device 8 includes a sleeve 81, a carrier 82, and two adjusting members 83. The sleeve 81 includes a compartment 810 receiving the carrier 82 having a side on which the long period fiber grating 5 is mounted. The adjusting members 83 are in the form of bolts respectively engaged in two openings of the sleeve 81. Each of two ends of the carrier 82 is fixed to an end of one of the adjusting members 83. The other end of each adjusting member 83 is located outside of the sleeve 81, so that the adjusting members 83 can be rotated to pull the ends of the carrier 82 in the axial direction, applying a pulling force to the long period fiber grating 5 in the axial direction to change the grating width of the long period fiber grating 5. The depth of the wave trough of the transmission spectrum of the long period fiber grating 5 is, thus, adjusted (see FIG. 8). Thus, the fiber optic grating measuring device according to the teachings of the present invention can provide differing measurement sensitivities according to needs.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A fiber optic grating measuring device comprising:
a wide-band light source;
an optical coupler coupled to the wide-band light source;
an output unit;
a long-period fiber grating including a first end coupled to the optical coupler and a second end coupled to the output unit;
a first fiber Bragg grating coupled to the optical coupler, with the first fiber Bragg grating serving as a measuring terminal and adapted to be mounted on an object having a physical quantity to be measured by the fiber optic grating measuring device; and
a second fiber Bragg grating coupled to the optical coupler, with the second fiber Bragg grating serving as a free terminal and located adjacent to the first fiber Bragg grating.

2. The fiber optic grating measuring device as claimed in claim 1, further comprising an adjusting device, with the long period fiber grating mounted on the adjusting device.

3. The fiber optic grating measuring device as claimed in claim 2, with the adjusting device including a clamp, a carrier, and an adjusting member, with the clamp including two clamping ends, with the carrier fixed between the two clamping ends, with the long period fiber grating mounted on a side of the carrier, with the adjusting member threadedly engaged with the clamp and extending through the clamp and including an end pressing against the side of the carrier.

4. The fiber optic grating measuring device as claimed in claim 3, with the adjusting member being a bolt.

5. The fiber optic grating measuring device as claimed in claim 2, with the adjusting device including a sleeve, a carrier, and two adjusting members, with the two adjusting members respectively engaged with two ends of the sleeve, with the carrier received in the sleeve and including two ends, with each of the two ends of the carrier fixed to an end of one of the two adjusting members, with the long period fiber grating mounted on a side of the carrier.

6. The fiber optic grating measuring device as claimed in claim 5, with each of the two adjusting members being a bolt.

7. The fiber optic grating measuring device as claimed in claim 1, with the wide-band light source being a light-emitted diode or a laser diode.

8. The fiber optic grating measuring device as claimed in claim 7, further comprising an Erbium doped fiber amplifier coupled with the wide-band light source to emit a wide-band light by amplifier spontaneous emission.

9. The fiber optic grating measuring device as claimed in claim 1, with the long period fiber grating being of external force type.

10. The fiber optic grating measuring device as claimed in claim 1, with the output unit being a spectrometer or a photoelectric diode.
